(19) United States
(12) Patent Application Publication
(10) Pub. No.: US 2026/0089634 A1
(43) Pub. Date: Mar. 26, 2026

(54) WAKE-UP RADIO PROTOCOL FOR WIRELESS COMMUNICATIONS

(71) Applicant: Cypress Semiconductor Corporation, San Jose, CA (US)

(72) Inventors: Rakesh Taori, McKinney, TX (US); Kiran Uln, Pleasanton, CA (US); Daniel Lee, Salt Lake City, UT (US)

(73) Assignee: Cypress Semiconductor Corporation, San Jose, CA (US)

(21) Appl. No.: 18/898,141

(22) Filed: Sep. 26, 2024

(51) Int. Cl. H04W 52/02

(52) U.S. Cl. CPC H04W 52/0235

(57) ABSTRACT

Systems and methods are described herein for implementing a wakeup radio protocol. An example method may include entering a wireless module of a wireless client into a power saving mode. The method includes detecting, by a wakeup radio, an RF signal exhibiting a pattern having a sequence of values. The method includes determining, by a processing device of the wakeup radio, that the pattern matches a wakeup word specified for the wireless client to cause the wireless module to wake from the power saving mode. The method includes sending a signal to the wireless module to cause the wireless module to transition from the power saving mode to an active mode.

### TECHNICAL FIELD

Aspects of the present disclosure generally relate to wireless technology, and in particular, a wake-up radio protocol used to support power saving techniques.

### BACKGROUND

Wireless network protocols such as Wi-Fi enables wireless communication between devices such as computers, smartphones, tablets, and Internet of Things (IoT) devices. Many wireless network protocols provide a power-saving mode to optimize power management by allowing devices to sleep for extended periods. Wireless devices can improve power efficiency by negotiating scheduled wake times during which the wireless devices are to wake up and receive or transmit data. Outside of scheduled wake times, the wireless device may enter a reduced power state to conserve power.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for providing power saving through the use of a wakeup radio, in accordance with some embodiments of the present disclosure.

FIG. 2 is a block diagram that illustrates an example system that includes multiple wakeup radios, in accordance with some embodiments of the present disclosure.

FIG. 3 is a process flow diagram of a method of waking a wireless client from a power saving mode, in accordance with some embodiments of the present disclosure.

FIG. 4 is a process flow diagram of a method of operating a wireless client, in accordance with some embodiments of the present disclosure.

FIG. 5 illustrates a diagrammatic representation of a machine in the example form of a computer system within which a set of instructions, for causing the machine to perform any one or more of the methodologies discussed herein for implementing a wakeup radio protocol.

### DETAILED DESCRIPTION

Wireless communication technologies have become pervasive throughout a wide variety of consumer, healthcare, and industrial applications, including smart home devices, industrial Internet of Things (IoT), health-monitoring devices, smart city devices, energy management, agricultural and environmental monitoring, and many others. Power efficiency may be a concern for many of these applications. For example, some wireless devices operate on battery power. Efficient use of power may allow such wireless devices to operate for longer periods of time without charging or replacing the battery.

Many wireless communication protocols implement protocols that enable power savings. For example, the Wi-Fi protocol includes targeted-wait-time (TWT) mechanism that improves power efficiency by negotiating scheduled wake times for the wireless devices to wake up and receive or transmit data. The wireless device is able to stay in a reduced power state in between wakeup intervals. At the scheduled wakeup interval, the wireless device wakes up to determine whether there is any data waiting to be transmitted to the wireless device. If so, the wireless device can begin network communications. If there is no data waiting to be transmitted, the wireless device can reenter the reduced power state. In many use cases, it can be expected that there will be no data to transmit during most wakeup times, in which case, the process of waking up wastes power.

In many use cases, the initiation of wireless communication is event triggered. For example, one type of event may be a user attempting to access a wireless device such as a doorbell camera, in which case, the wireless device should be able to respond in a timely manner. In such use cases (i.e., that demand high availability), the wakeup interval will generally be configured to reduce latency, which means that the wakeup interval will be relatively short (e.g., hundreds of milliseconds) even though the probability of occurrence of the triggering event is very small at any time of the day. In some use cases, the wireless device may even be configured to be constantly available, without ever entering a reduced power state. High availability implies higher power consumption resulting in shorter battery lives.

The present disclosure addresses the above-noted and other deficiencies by providing a wakeup radio protocol for waking up a wireless device. In accordance with embodiments disclosed herein, the wakeup radio is a low power device that is included in the wireless device and communicatively coupled to a wireless communication module. The wakeup radio stays on (no reduced power state) and continuously monitors for a signal, referred to herein as a wakeup word, indicative of a triggering event. Upon receipt of the wakeup word, the wakeup radio sends a signal to the wireless communication module that forces the communication module to wake from the power saving state. In this way, the wireless device can respond to the triggering event even between wakeup intervals. Accordingly, the wakeup interval can be extended or even eliminated without increasing response latency in high availability applications. Thus, the wireless device is able to conserve power by remaining in the power saving state for longer periods of time.

As discussed herein, the present disclosure provides an approach that improves the operation of a computer system by implementing a wakeup radio that enables a wireless device to wake from a power saving state without having to periodically wake itself in accordance with a predetermined schedule. In addition, the present disclosure provides an improvement to the technological field of wireless technology by providing a wakeup protocol that results in longer sleep times and reduced battery consumption. By way of example, the following description may refer to the Wi-Fi protocol (i.e., the IEEE 802.11 WLAN protocol). However, embodiments of the present disclosure may be implemented in any suitable wireless communication protocol, including Wi-Fi, Bluetooth, Zigbee (IEEE 802.15.4), Wireless Universal Serial Bus (USB), and others.

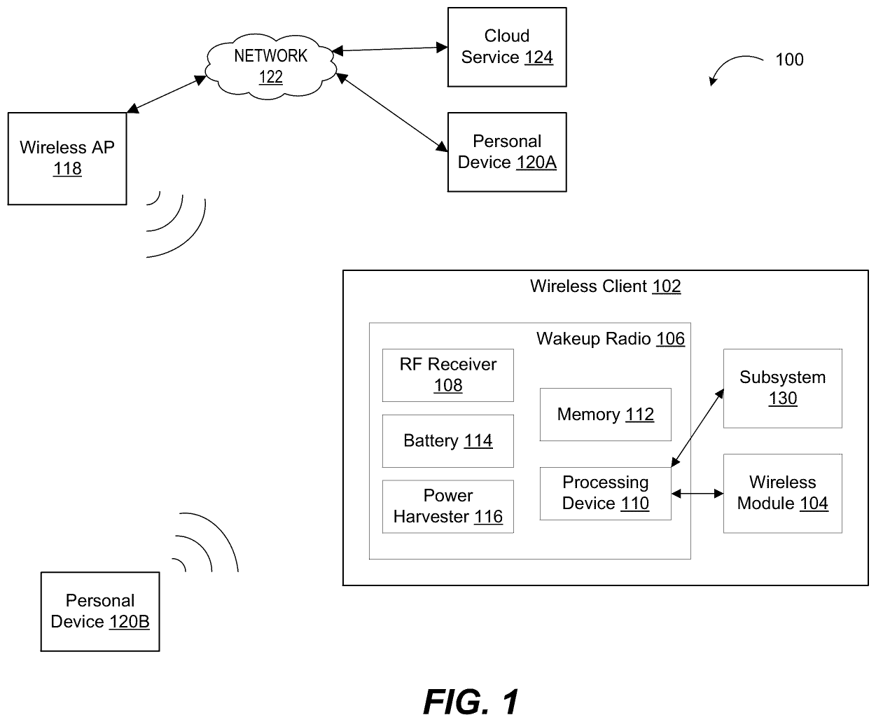

FIG. 1 is a block diagram that illustrates an example system for providing power saving through the use of a wakeup radio, in accordance with some embodiments of the present disclosure. The example system 100 includes a wireless client 102 having wireless networking capabilities. The wireless client 102 may be any suitable type of electronic device and may be an edge device (e.g., network endpoint). For example, the wireless client 102 may be an IoT device (e.g., IoT sensor), a smart home device (e.g., smart thermostat, lock, lighting, etc.), a security camera, a health monitoring device, wearable medical sensors, smart cities device (e.g., smart lighting, parking meter, traffic monitor), energy management device (e.g., smart electricity meter), consumer electronics (e.g., television, wireless speaker, etc.), and others.

In some embodiments, the wireless client 102 may be a non-Access Point station (non-AP STA), which refers to a device that is equipped with a wireless network interface controller and uses a Wi-Fi protocol to connect to other devices or networks, but does not have access point capability. An Access Point (AP) is a specialized type of station that serves as a central transmitter and receiver of wireless radio signals. A station that has access point capability is typically referred to as an AP, a wireless access point (WAP), or a simply a station (STA). A station that does not have access point capability is typically referred to as non-AP station (non-AP STA). Non-AP stations are typically end devices (e.g., IoT devices) that communicate with a station (e.g., wireless AP 118) to gain network connectivity.

The wireless client 102 includes a wireless module 104 that enables the wireless client to access one or more wireless networks. The wireless module 104 may use any suitable wireless protocol, including Wi-Fi, Bluetooth, and others. The wireless module 104 may also be configured to operate in accordance with a combination of different protocols. For example, the wireless module may be Wi-Fi and Bluetooth capable. Additionally, it will be appreciated that although a single wireless module is shown, the wireless client 102 may include two or more wireless modules 104, each for accessing a different type of wireless network.

The system also includes a wireless access point AP 118 configured to communicate with the wireless client 102 via the wireless module 104. The wireless AP 118 may serve as a central transmitter and receiver of wireless radio signals. If the wireless AP 118 uses the Wi-Fi protocol, it may be referred to as a wireless access point (WAP) or a station (STA). However, it will be appreciated that the wireless AP 118 may use any suitable communication protocol. The wireless AP 118 may also be communicatively coupled to a network 122, which may be a public network (e.g., the Internet), a private network (e.g., a local area network (LAN), wide area network (WAN)), or a combination thereof. For example, the network 122 may be an enterprise network of a facility such as a hospital, warehouse, manufacturer, or other business enterprise. The network 122 may also be a public network, such as the Internet. For example, the wireless AP 118 may be a home wireless router connected to the Internet via an Internet service provider. In some embodiments, the wireless AP 118 may be a wireless repeater that extends the range of the wireless network.

The system 100 may also include one or more personal devices 120A-B capable of communicating with the wireless client 102. The personal devices 120A-B may be any suitable type of end user electronic equipment, such as a smart phone, personal computer (e.g., desktop, laptop, etc.), tablet computer, and the like. The personal device 120A may be configured to communicate with the wireless client 102 through the network 122 and wireless AP 118. For example, the personal device 120A may be smart phone connected to the Internet via a cellular data provider or Wi-Fi hotspot. The personal device 120A may also be a personal computer (e.g., desktop, laptop, tablet) connected to the wireless AP 118 through a wired network (e.g., Ethernet), wireless network (e.g., Wi-Fi), or combination thereof. The personal device 120B may be configured to communicate with the wireless client 102 through direct wireless communication (e.g., Wi-Fi, Bluetooth, and others).

The wireless client 102 may be configured to enter various power saving modes, whereby components of the wireless client 102 are fully or partially powered down. For example, the wireless client 102 may enter a power saving mode that powers down the wireless module 104 or portions thereof such as the wireless module's transceiver. The wireless client 102 may be configured to implement a wakeup interval such that the wireless module 104 will periodically exit the power saving mode to determine whether there is any traffic waiting to be transmitted to the wireless client 102. With respect to Wi-Fi embodiments, the power saving mode may be a Wireless Network Management (WNM) sleep mode or a target wait time (TWT) sleep mode. WNM sleep mode is an extended power-saving mode for non-AP stations that causes the station to skip a specified number of Delivery Traffic Indication Message (DTIM) Beacon frames in accordance with a listen interval. The TWT sleep mode is a power save mode wherein the station specifies a time interval for waking to determine if network traffic is available for the station. Other power save modes are also possible.

The wireless client 102 also includes a wakeup radio 106, which is configured to cause the wireless client 102 (e.g., wireless module 104) to transition from the power saving mode to an active mode. In the active mode, the wireless module 104 may be turned on and operable such that the wireless client 102 is able communicate with the wireless AP 118 to send and receive data wirelessly. The wakeup radio 106 is configured to be continuously active and listening for a wakeup word to be transmitted wirelessly (e.g., by the wireless AP 118 or the personal device 120B).

The wakeup radio 106 may include a Radio Frequency (RF) receiver 108, a processing device 110, and a memory 112. The RF receiver 108 is configured to receive radio-frequency signals and may include circuitry used to receive and decode radio-frequency signals. The RF receiver 108 may be configured to operate at any suitable frequency or range of frequencies, which may be the same as or different from the frequency range of the wireless module 104. Additionally, the RF receiver 108 and the wireless module 104 may be coupled to the same antenna or antenna array. However, in some embodiments, the RF receiver 108 may also be coupled to a separate antenna included as a component of the wakeup radio 106 and dedicated for the use of the wakeup radio 106.

The processing device 110 may be an application specific integrated circuit (ASIC), a field programmable gate array (FPGA), a microcontroller, etc. The memory 112 may be one or more of a random-access memory (RAM), a solid-state memory (e.g., flash memory), Read-only memory (ROM), a cache, etc. In some embodiments, the memory 112 may be an integrated component of the processing device 110. Additionally, the memory 112 may be a read-only memory, a writable memory, or a combination thereof.

In some embodiments, the wakeup radio 106 can include a battery 114, which provides electrical power to operate the RF receiver 108, processing device 110, and memory 112. The battery 114 may be rechargeable. The wakeup radio 106 can also include a power harvester 116 used to recharge the battery 114. The power harvester 116 may be configured to derive electrical energy from any suitable ambient energy source, such as visible light (photovoltaic), thermal energy (e.g., thermoelectric), kinetic energy (e.g., piezoelectric), radio waves, and the like. The wakeup radio 106 may also be powered by an external energy source such as a battery of the wireless client 102 or AC power provided to the wireless client 102.

The RF receiver 108 can receive wireless signals and decode the signals to generate digital data, which is communicated to the processing device 110. The processing device 110 may then determine whether the received digital data matches the wakeup word. Upon detection of the wakeup word, the wakeup radio 106 signals the wireless module to enter the active mode. If the wireless client 102 is in a power saving mode at the time, the wireless client 102 exits the power saving mode and enters the active mode, in which case the wireless module 104 is powered on. Once powered on, the wireless module 104 can listen for wireless communications directed to the wireless client 102. For example, the wireless module 104 may receive a Beacon from the wireless AP 118 or the personal device 120B indicating that data packets are waiting to be transmitted to the wireless client 102. Wireless communications may then proceed as normal in accordance with the relevant wireless communication protocol.

The wakeup word may be a specific sequence of symbols, such as a specific pattern of ones and zeros. The wakeup word may be transmitted by the same transmitter used to communicate with wireless module 104. For example, if the wireless module 104 and the wireless AP 118 are communicating using the Wi-Fi protocol, then the wireless AP 118 may use the same Wi-Fi transceiver to transmit the wakeup word as is used to transmit Wi-Fi data packets. In such examples, the wakeup word may be encoded in a data packet or data frame of applicable communication protocol. For example, the wakeup word may be transmitted as part of a Wi-Fi or Bluetooth beacon frame. The wakeup word can also be transmitted as part of an initial control frame (ICF) such as a Request to Send (RTS) or Clear to Send (CTS) control frame, multi-user (MU) RTC or CTS, an acknowledgement control frame (ACK), a block acknowledgement request (BAR), and others.

In some embodiments, the wakeup word may be transmitted through separate circuitry (e.g., separate wakeup transmitter), which is separate from the circuitry used to communicate with the wireless module 104 of the wireless client 102. For example, the wakeup word may be transmitted using a first communication protocol (e.g., Bluetooth) to wake a wireless module that uses a different communication protocol (e.g., Wi-Fi) or in a completely different RF band, like 900 MHz. In some embodiments, the wakeup word may be transmitted using a custom, ad hoc, or non-standard communication protocol. The wakeup radio 106 can be configured to constantly monitor all of the wireless signals that it detects, regardless of what type of packet or frame the wakeup word is associated with. For example, a Wi-Fi packet targeting a different wireless client (not shown) may include a wakeup word targeting the depicted wireless client 102. Since the wakeup radio 106 does not filter out the received signals based on destination, the presence of the wakeup word in a data packet meant for another wireless client can be used to wake the depicted wireless client 102. Additionally, several wakeup words can be embedded in the same data packet or data frame.

The wakeup word may be stored in memory 112. In some embodiments, the wakeup radio 106 is programmed with a static wakeup word, meaning that the wakeup word for the wireless client 102 does not change. In such embodiments, the wakeup word may be programmed into the wakeup radio 106 using a small amount of read-only memory, such as electrically erasable programmable read-only memory (EEPROM). Additionally, the wireless module 104 may be configured to send one or more setup parameters to the wakeup radio 106, wherein the setup parameters include the wakeup word that the wakeup radio 106 is configured to listen for.

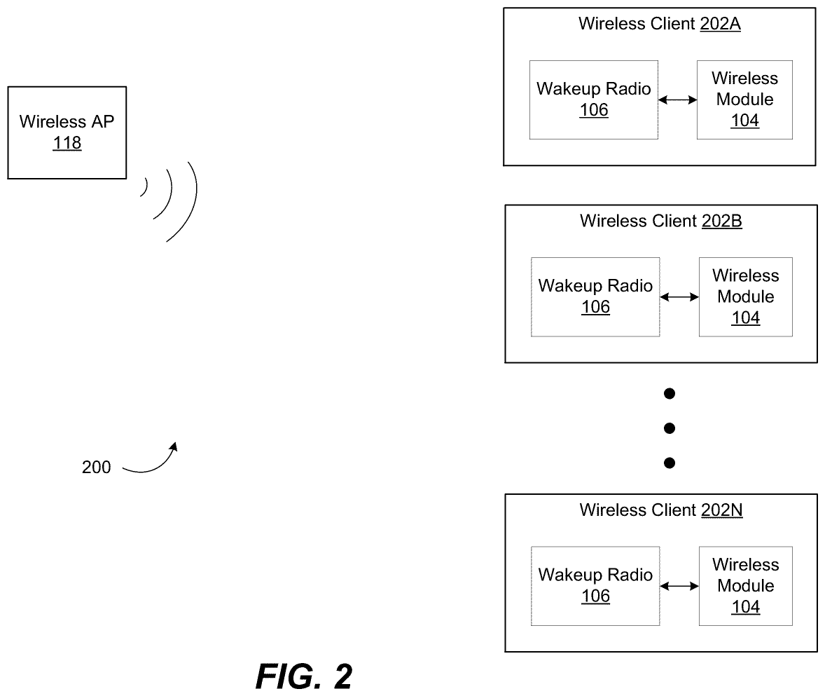

In other embodiments, the wakeup word can be re-programmed during deployment. For example, the wakeup radio 106 may receive one or more setup parameters from the wireless module 104, wherein the setup parameters include the wakeup word that the wakeup radio 106 is configured to listen for. If there are several wireless clients 102 in communication with the wireless AP 118, each having a wakeup radio 106, the wireless AP 118 and the wireless clients 102 can coordinate to ensure that each wireless client 102 is associated with a unique wakeup word. This enables specific wireless clients 102 to be woken up individually or in clusters. A system with several wireless clients 102 is described further in relation to FIG. 2. In embodiments where the wakeup word is negotiated between the wireless client 102 and the wireless AP 118, the wakeup word negotiation may be carried out by the wireless module 104 and once the wakeup word is established, the wireless module 104 may send the wakeup word to the wakeup radio 106 to be stored to the memory 112.

The wireless client 102 may also periodically obtain a new wakeup word. For example, the wakeup radio 106 may implement an entropy-based wakeup word change. Changing the wakeup word over time can help to improve security by preventing an unauthorized user from learning the wakeup word.

When the wakeup radio 106 detects the wakeup word in use by the wireless client 102, the processing device 110 may send a wake signal to the wireless module 104. In some embodiments, the wake signal may be sent to the wireless module 104 using any suitable chip-to-chip communication protocol, such as SPI (Serial Peripheral Interface), I2C (Inter-Integrated Circuit), and others. The wake signal may be sent to the wireless module 104 via a single signal line.

If the wireless module 104 is in a power saving mode subject to a wakeup interval (e.g., TWT interval), the wake signal will cause the wireless module 104 to enter the active mode early, i.e., prior to the next scheduled wake time. In this way, the wireless client 102 is able to implement longer wakeup intervals without an increase in latency between a triggering event and the wireless module 104 becoming active. Additionally, the techniques described herein also enable the wireless module 104 to enter an indefinite power saving mode, i.e., a power saving mode without a scheduled wake time or wakeup interval. Accordingly, the use of the wakeup radio 106 allows the wireless module 104 to stay in the power saving mode for longer periods of time, thereby conserving power and extending battery life.

The wireless AP 118 may include code (e.g., software, firmware) that is executable to issue wakeup words targeted to wake up specific wireless devices. The code may be pre-installed by the manufacturer or by an IT management team, for example. In some embodiments, the software code may be downloaded to the wireless AP 118 as part of a procedure for configuring the wireless client 102. Such software may downloaded from a cloud service 124 that provides services associated with the wireless client 102. For example, upon purchasing a new device such a smart home device, the user may download an app to configure the smart home device and associate the device with a user account registered with the cloud service 124. As part of the configuration process, the user may provide information (e.g., IP address) that enables the cloud service 124 to install an application on the user's wireless AP 118. In some embodiments, the cloud service 124 also provides the wakeup word associated with the wireless client 102 to the wireless AP 118.

As mentioned above, the wakeup word may be transmitted by the wireless AP 118 (e.g., home router, wireless repeater, etc.) and/or the personal device 120B (e.g., smart phone, tablet, etc.). Various scenarios for waking the wireless client 102 from a power saving mode may be implemented depending on the details of a specific situation and/or system design. In one example, the wireless client 102 may be home electronic equipment such as a video camera, and the user may wish to view a current video stream via their smart phone (e.g., personal device 120A). In this situation, the user may activate an app on their personal device 120A to connect to the wireless client 102 by accessing the wireless AP 118 (e.g., home router) through the network 122 (e.g., the Internet.) In some embodiments, access to the wireless client 102 may also be performed through the cloud service 124, which may serve as a management system running in a cloud computing platform. For example, the cloud service 124 may verify user credentials, apply user account settings, enable the selection of specific smart home devices (e.g., specific security cameras), and others.

When the wireless AP 118 receives data packets identifying the wireless client 102 as the destination, the wireless AP 118 may transmit a signal (e.g., DTIM Beacon frame) informing the wireless client 102 that there is data waiting to be transmitted to the wireless client 102.

Additionally, wireless AP 118 may also transmit a wakeup word targeting the wireless client 102 in case the wireless client 102 is in a power saving mode. The wireless AP 118 may transmit the wakeup word in the same beacon frame as the signal informing the wireless client 102 of waiting data. However, the wakeup word can be transmitted in a variety of ways depending on the design details of a particular implementation. For example, the wakeup word can be transmitted in the next data packet to be transmitted, including data packets intended for other wireless clients. Additionally, in a mixed mode configuration, the wakeup word for waking the Wi-Fi module may be transmitted using a Bluetooth beacon frame or Bluetooth data packet and vice-versa. The wakeup word can also be transmitted using separate circuitry dedicated specifically to generating and transmitting wakeup words.

Upon detecting the wakeup word, the wakeup radio 106 may send a signal to the wireless module 104, causing it to enter active mode. Once active, the wireless module 104 may begin communicating with the wireless AP 118 in the normal course (e.g., read the next DTIM beacon frame, etc.). The video camera can then begin streaming video to the user's personal device 120A over the network 122.

In some examples, if the user is in the same general area as the wireless client 102, the personal device 120B may transmit the wakeup word directly to the wireless client 102 rather than relying on the wireless AP 118 to transmit the wakeup word. For example, the wireless client 102 could be a smart light bulb, smart thermostat, smart door lock, and the user may want to control the wireless client 102 through the user's personal device 120B, which may be a smart phone for example. The user may activate an app on their personal device 120B and select a control feature to control a feature of the wireless client 102 (e.g., turn light on or off, adjust thermostat, unlock door, etc.). Upon selection of the control feature, the personal device 120B may be configured to transmit the wakeup word using the smart phone's existing RF capabilities such as Wi-Fi,, Bluetooth, cellular voice (e.g., GSM (Global System for Mobile Communications)), and/or cellular data (e.g., 4G, 5G, LTE, etc.). In some embodiments, the wakeup word may be transmitted to the wireless client 102 in a data packet being sent to the wireless AP 118. Since the wireless client 102 can be configured to monitor all wireless signals, the wireless client 102 can detect the wakeup word even if the wakeup word is embedded in a data packet having a separate destination.

In some embodiments, the wakeup radio 106 can wake an additional subsystem 130 of the wireless client 102 separately from the wireless module 104. The subsystem 130 may be any suitable subsystem of the wireless client 102, including an imaging module for capturing still pictures or video, a sound recording module, a sensor module used to monitor a feature of the environment such as temperature, an actuator module for generating control signals to control smart home devices, and others. Upon detection of the wakeup word, the subsystem 130 may be activated in addition to or instead of the wireless module 104.

In some embodiments, the subsystem 130 is activated first and the wireless module 104 is activated later when there is data to report or to report success or failure of a task. For example, the wireless device may be an IoT device and the subsystem 130 may be a sensor module equipped with a one or more temperature sensors. Upon detecting the wakeup signal, the wakeup radio 106 may send a wake signal to the sensor module to cause it to transition from a power saving mode to the active mode. Upon waking, the sensor module may begin recording a series of temperature measurements. The wakeup radio 106 or the subsystem 130 may then activate the wireless module 104 so that it can report the collected sensor data.

Upon waking, the subsystem 130 may perform a set of actions (e.g., recording sensor measurements) that are pre-programmed into the subsystem 130. For example, the subsystem 130 may be programmed such that, upon waking, the subsystem 130 records a single sensor reading, sends it to the processing device 110, and transitions back to the power saving mode. Additionally, some actions performed by the subsystem 130 may be determined based on instructions or information received through the wireless module 104 after the detection of the wake word. For example, the wakeup radio 106 may send wake signals to both the subsystem 130 and the wireless module 104 upon detection of the wake word. Upon waking, the wireless module 104 may receive a task request instructing the wireless device 102 to perform a task, such as making several measurements over a specified period of time and/or at a specified interval.

FIG. 2 is a block diagram that illustrates an example system that includes multiple wakeup radios, in accordance with some embodiments of the present disclosure. The example system 100 includes a number of wireless clients 202A-N having wireless networking capabilities and connected to the wireless AP 118. The wireless clients 102A-N are similar to the wireless client 102 and can include the wakeup radio 106 and the wireless module 104 as described in relation to FIG. 1.

In the embodiment shown in FIG. 2, the wakeup radio 106 of each wireless client 202A-N is associated with a unique wakeup word so that individual wireless clients 202A-N can be woken up independently. Waking up certain equipment independently may be useful in scenarios where a large number of wireless devices are operating in a same environment. For example, in a hospital setting there may be multiple wireless clients 102A-N (e.g., monitors and other medical equipment) associated with each patient. In a factory setting, there may be multiple pieces of machinery that are being monitored by multiple wireless clients 102A-N (e.g., IoT sensors). In such settings, it may often be the case that not all of the equipment needs to be active at all times. Selectively activating each wireless client 102A-N individually at separate times may help to prevent network congestion.

In some embodiments, the wakeup words (i.e., the specific code or waveform used to wake a specific wireless client 102 may be negotiated between the wireless AP 118 and each wireless client 102. For example, the wireless client 102 may specify a particular wakeup word, and the wireless AP 118 can confirm that the wakeup word has been received and is not in use by another wireless client 102. In another example, the wireless AP 118 may select the wakeup words to be assigned to each of the wireless clients 102A-N, and the wireless clients 102A-N acknowledge receipt of the wakeup words. The wireless clients 102A-N and the wireless AP 118 may also confirm that they have wakeup word capability.

Once a wakeup word has been established for a particular wireless client 102A-N, the wireless AP 118 can wake the wireless client 102A-N as described in relation to FIG. 1. Each wireless client 102A-N may implement an indefinite power saving mode so that the wireless clients 102A-N only wake when instructed to by the wireless AP 118.

In some scenarios, it may be useful to wake up clusters of wireless clients at a time. For example, an office or apartment building may have several smoke detectors and/or fire alarms, each associated with a different one of the wireless clients 102A-N. The wireless clients 102A-N may be configured to communicate with a central management system to report their status. For example, it may be useful to wake up the smoke detectors on a specific floor of the building. To wake up several wireless clients 102A-N at one time, several wakeup signals may be embedded in the same data packet (e.g., same Wi-Fi data packet, same beacon frame, etc.). Additionally, some wakeup signals may be configured to wake up a particular group of the wireless clients 102A-N which are programmed to recognize a wakeup word common to all of the wireless clients in the designated group.

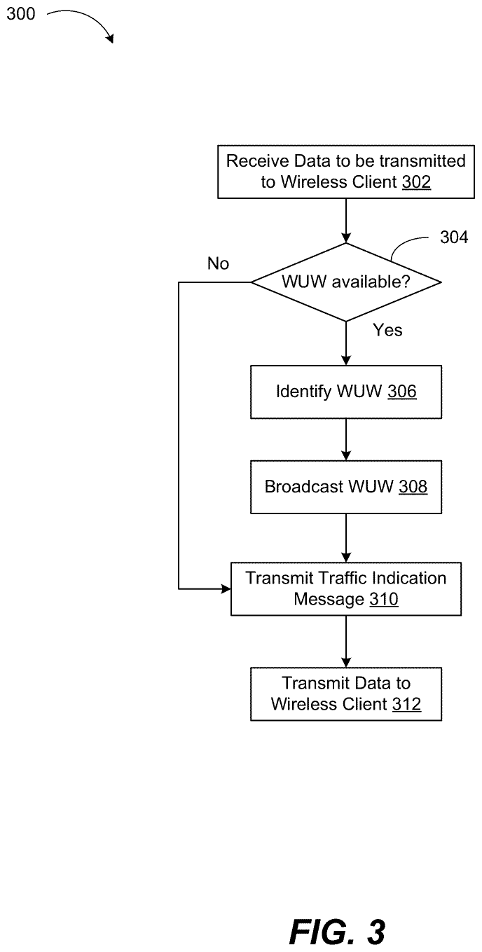

FIG. 3 is a process flow diagram of a method of waking a wireless client from a power saving mode, in accordance with some embodiments of the present disclosure. Method 300 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 300 may be performed by the wireless AP 118 or personal device 120B shown in FIG. 1. The method 300 may begin at block 302.

At block 302, data to be transmitted to a wireless client is received. In the case of a Wireless AP, the data may be received from another device connected to the wireless network, or through an Internet service provider, for example. In the case of a personal device such as a smart phone, the data may be a user command to control a smart home device, such as a door lock, thermostat, lights, etc. For example, the data may be an instruction to turn a one or more lights on or off, lock or unlock a door, etc. The data may identify a destination for the data such as an IP address of the wireless client.

At block 304, a determination is made regarding whether a wakeup word (WUW) is available for the wireless client identified as the destination for the data. For example, the wireless AP may use a lookup table that associates each wireless device with a wakeup word to be used for the wireless client. In some embodiments, not every wireless client will be equipped with a wakeup radio and will therefore not be associated with a wakeup word. If the wireless client identified as the destination is not associated with a wakeup word, the process flow may advance to block 310 and communication with the wireless client resumes in accordance with the wireless communication protocol in use.

If the wireless client is associated with a wakeup word, the process flow advances to block 306 and the applicable wakeup word is identified. For example, the wakeup word may be retrieved from the lookup table. The wakeup word may be a sequence of values, for example, a sequence of ones and zeros to be encoded as an RF signal with a waveform or pattern that represents the sequence of values.

At block 308, the wakeup word is transmitted. In some embodiments, the wakeup word may be transmitted in a control frame (e.g., beacon frame) or a data packet intended for another wireless client in the network. In other words, even though the wakeup word is intended to wake the wireless client identified as the destination for the data received at block 302, the wakeup signal may be embedded in a data packet addressed to a different wireless client. Thus, the wakeup word may be embedded in a next data packet to be transmitted regardless of the destination for data packet carrying the wakeup word. In some embodiments, several wakeup words may be transmitted within a same data packet or data frame.

At block 310, the communication with the wireless client resumes in accordance with the wireless communication protocol in use. In some embodiments, may transmit a traffic indication message (e.g., a Wi-Fi DTIM), which notifies any wireless clients listening that data is waiting to be transmitted.

At block 312, the data received at block 302 is transmitted to the wireless client. By the time the data is transmitted, the wireless client will have had time to transition from the power saving mode to the active mode.

The method 300 illustrates example functions used by various embodiments. Although specific function blocks (“blocks”) are disclosed in method 300, such blocks are examples. That is, embodiments are well-suited to performing various other blocks or variations of the blocks recited in method 300. It is appreciated that the blocks in method 300 may be performed in an order different than presented, and that not all of the blocks in method 300 may be performed.

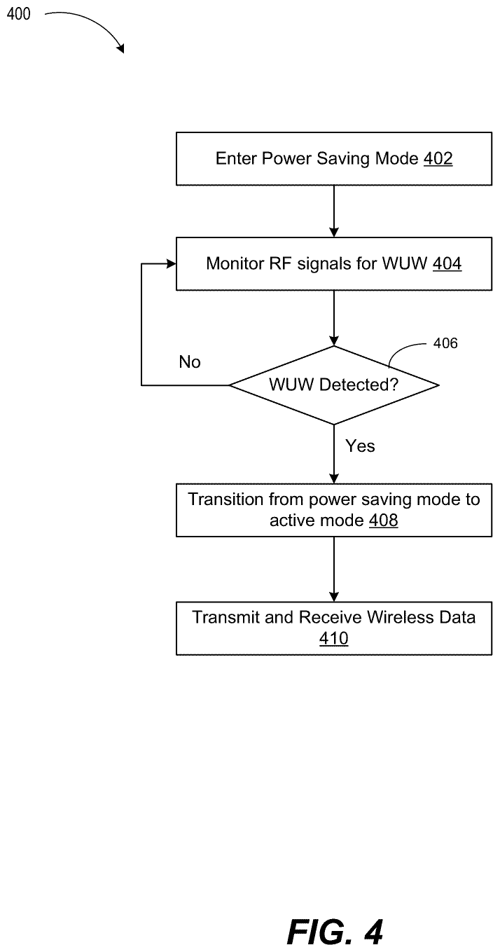

FIG. 4 is a process flow diagram of a method of operating a wireless client with a wakeup radio, in accordance with some embodiments of the present disclosure. Method 400 may be performed by processing logic that may include hardware, software, firmware, or a combination thereof. In some embodiments, at least a portion of method 400 may be performed by the wireless client 102 shown in FIG. 1 or one of the wireless clients 102A-N shown in FIG. 2. The method 400 may begin at block 402.

At block 402, the wireless client enters a power saving mode. The power saving mode may be any type of power saving mode wherein the wireless client or selected components thereof (e.g., wireless module, transceiver, or other subsystems) are powered down and/or entered into a sleep state to conserve power. With respect to Wi-Fi embodiments, the power saving mode may be a WNM sleep mode or a target wait time TWT sleep mode. Other power saving modes are also possible in accordance with embodiments.

At block 404, the wireless client begins monitoring any received RF signals for the wakeup word applicable to wireless client. The monitoring may be performed by the wakeup radio 106 shown in FIGS. 1 and 2. Monitoring for the wakeup word may involve monitoring RF transmissions to detect a waveform pattern that matches the wakeup word programmed into the wireless client, which may be represented as a sequence of values programmed into the wakeup radio's memory 112. The detection of the waveform pattern is agnostic to the particular package used to carry the wakeup word. For example, the wakeup word may be embedded in a Wi-Fi beacon frame, a data packet addressed to another wireless client, etc. Additionally, in a mixed mode configuration the wakeup word may be embedded in a data frame or packet of a different communication protocol (e.g., Bluetooth) as compared to the main wireless communication protocol used by the wireless client for regular network communications (e.g., Wi-Fi).

If, at block 406, the wakeup word is not detected, the process flow returns to the block 404 and the wireless client continues monitoring. If the wakeup word if detected, the process flow advances to block 408.

At block 408, the wireless client transitions from the power saving mode to the active mode. To transition the wireless client to active mode, the wakeup radio may send wake signals to the wireless client's wireless module (e.g., Wi-Fi module, Bluetooth module, etc.) and/or other subsystems (e.g., subsystem 130 of FIG. 1). In some embodiments, transitioning the wireless client to active mode causes a subsystem of the wireless client to perform one or more pre-programmed actions, as described above in relation to FIG. 1, and the wireless module may be activated to report the results of the actions (e.g., success, failure, data collected, etc.). The wake word may also indicate that there is data waiting to be transmitted to the wireless client. Accordingly, transitioning the wireless client to active mode can also include activating the wireless module to receive data. The wake signal causes the wireless module to exit from the power saving mode so that it is prepared to send or receive data over the wireless network. In some embodiments, the wireless module may also receive a traffic indication message (e.g., a Wi-Fi DTIM).

At block 410, wireless data is transmitted and/or received by the wireless module in accordance with the wireless communication protocol in use. For example, the wireless module may receive Wi-Fi data packets that identify the wireless client as the destination for the data. Additionally, the wireless module may transmit Wi-Fi data packets addressed to a destination such as the personal device 120A or 120B or cloud service 124. It will be appreciated that, in some cases, there may not be any information to send or receive. In such cases, the wireless module may not be activated and block 410 can be skipped. After any pre-programmed or requested actions have been performed (or have been attempted), and if there is no more data to be transmitted or received by the wireless client, the wireless client may transition back to the power saving mode at block 402.

The method 400 illustrates example functions used by various embodiments. Although specific function blocks (“blocks”) are disclosed in method 400, such blocks are examples. That is, embodiments are well-suited to performing various other blocks or variations of the blocks recited in method 400. It is appreciated that the blocks in method 400 may be performed in an order different than presented, and that not all of the blocks in method 400 may be performed.

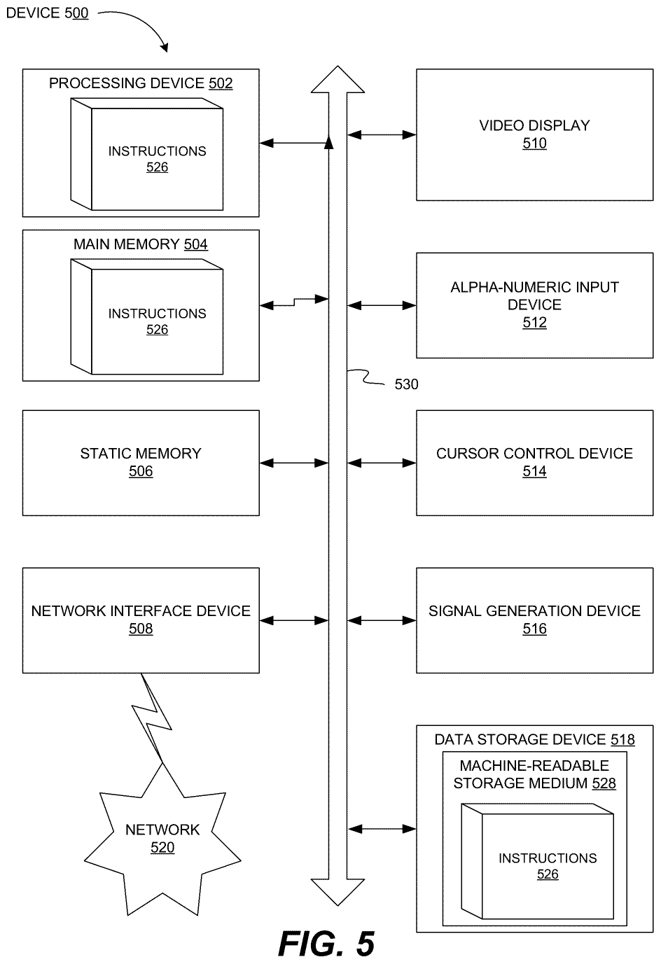

FIG. 5 illustrates a diagrammatic representation of a machine in the example form of a computer system 500 within which a set of instructions, for causing the machine to perform one or more of the methodologies discussed herein for implementing a wakeup radio protocol.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 500 may be representative of a server.

The exemplary computer system 500 includes a processing device 502, a main memory 504 (e.g., read-only memory (ROM), flash memory, dynamic random access memory (DRAM), a static memory 509 (e.g., flash memory, static random access memory (SRAM), etc.), and a data storage device 518 which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing system 500 may further include a network interface device 508 which may communicate with a network 520. The computing system 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 519 (e.g., a speaker). In some embodiments, video display unit 510, alphanumeric input device 512, and cursor control device 514 may be combined into a single component or device (e.g., an LCD touch screen).

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like.

The data storage device 518 may include a machine-readable storage medium 528, on which is stored one or more sets of instructions 526 (e.g., software) embodying any one or more of the methodologies of functions described herein. The instructions 526 may also reside, completely or at least partially, within the main memory 504 or within the processing device 502 during execution thereof by the computer system 500; the main memory 504 and the processing device 502 also constituting machine-readable storage media. The instructions 526 may further be transmitted or received over a network 520 via the network interface device 508. The instructions 526 may be configured for performing any of the techniques described herein, such as identifying and transmitting a wakeup word and/or transitioning from a power saving mode to an active mode in response to a wakeup word.

The machine-readable storage medium 528 may also be used to store the instructions 526 for performing the techniques described herein. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “determining,” “identifying,” “embedding,” “broadcasting,” “transmitting,” “receiving,” “sending,” “negotiating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
entering a wireless module of a wireless client into a power saving mode;
detecting, by a wakeup radio, a radio frequency (RF) signal exhibiting a pattern comprising a sequence of values;
determining, by a processing device of the wakeup radio, that the pattern matches a wakeup word specified for the wireless client to cause the wireless module to wake from the power saving mode; and
sending a signal to the wireless module to cause the wireless module to transition from the power saving mode to an active mode.

2. The method of claim 1, wherein entering the power saving mode comprises establishing a wakeup interval, wherein the wakeup word causes the wireless module to transition from the power saving mode to the active mode prior to a next scheduled wake time.

3. The method of claim 1, wherein entering the power saving mode comprises entering an indefinite power saving mode, and wherein the wireless module stays in the power saving mode until the wakeup word is received.

4. The method of claim 1, the method further comprising negotiating the wakeup word with a wireless access point and storing the wakeup word to a writable memory of the wakeup radio.

5. The method of claim 1, the method further comprising receiving the wakeup word from a read-only memory of the wakeup radio.

6. The method of claim 1, the method further comprising establishing a new wakeup word after a time period has expired.

7. The method of claim 1, wherein the wireless module is a Wi-Fi module and the wakeup word is detected in a Wi-Fi beacon frame.

8. The method of claim 1, wherein the wireless client is a first wireless client and the wakeup word is detected in a data packet addressed to a second wireless client.

9. The method of claim 1, wherein the wireless module operates according to a first communication protocol and wherein the wakeup word is detected in a data packet generated in accordance with a second communication protocol.

10. An apparatus comprising:
a wireless module configured to transmit and receive wireless data in accordance with a wireless communication protocol; and
a wakeup radio comprising a receiver and a processing device, the processing device configured to:
compare a radio frequency (RF) signal received by the receiver to a wakeup word;
and
if the RF signal matches the wakeup word, send a wake signal to the wireless module to cause the wireless module to transition from a power saving mode to an active mode.

11. The apparatus of claim 10, wherein the wireless module is configured to establish a wakeup interval and enter the power saving mode, wherein the wakeup word causes the wireless module to transition from the power saving mode to the active mode prior to a next scheduled wake time.

12. The apparatus of claim 10, wherein the wireless module is configured to enter an indefinite power saving mode, and wherein the wireless module stays in the power saving mode until the wakeup word is received.

13. The apparatus of claim 10, wherein the wireless module is configured to send one or more setup parameters to the wakeup radio, wherein the setup parameters comprise the wakeup word that the wakeup radio is configured to listen for.

14. The apparatus of claim 10, wherein the wakeup radio is configured to send one or more setup parameters to the wireless module, wherein the setup parameters comprise the wakeup word that the wakeup radio is configured to listen for.

15. The apparatus of claim 10, wherein the wireless module is configured to establish a new wakeup word after a time period has expired.

16. The apparatus of claim 10, wherein the wireless module is a Wi-Fi module and the wakeup word is detected in a Wi-Fi beacon frame.

17. The apparatus of claim 10, wherein the apparatus is a first wireless client and the wakeup word is detected in a data packet addressed to a second wireless client.

18. The apparatus of claim 10, wherein the wakeup radio comprises a power harvester configured to power the wakeup radio using ambient energy.

19. A method comprising:
receiving data to be wirelessly transmitted to a wireless client;
identifying a wakeup word associated with the wireless client;
transmitting a traffic indication message to the wireless client to inform the wireless client that the data is about to be delivered; and
prior to transmitting the traffic indication message, broadcasting the wakeup word to cause the wireless client to wake from a power saving mode.

20. The method of claim 19, wherein the wireless client is a first wireless client, and wherein broadcasting the wakeup word comprises transmitting a data packet addressed to a second wireless client and including the wakeup word associated with the first wireless client in the data packet addressed to the second wireless client.
